(19) United States
(12) Patent Application Publication
(10) Pub. No.: US 2014/0059130 A1
(43) Pub. Date: Feb. 27, 2014

(54) SYSTEM AND METHOD FOR UPDATING CONNECTIONS IN SOCIAL NETWORKS

(71) Applicant: MAINSOFT R&D LTD., Lod (IL)

(72) Inventor: Roy Sheinfeld, Tel Aviv (IL)

(73) Assignee: MAINSOFT R&D LTD., LOD (IL)

(21) Appl. No.: 13/853,297

(22) Filed: Mar. 29, 2013

Related U.S. Application Data
(60) Provisional application No. 61/691,811, filed on Aug. 22, 2012.

(51) Int. Cl. H04L 29/06

(52) U.S. Cl. CPC H04L 65/403
USPC 709/204

(57) ABSTRACT

A method for updating connections in social networks is disclosed. The method comprises analyzing information collected respective of a user, wherein the collected information relates to communication of the user with other connections through at least one application installed on a device of the user; determining connections that are of interest to the user based on the analysis information, wherein each of the determined connections is assigned with at least a communicative value; creating a user profile to include the determined connections and their respective communicative value; and updating, based on the created user profile, a connection list of the user in at least one social network to which the user is subscribed.

### CROSS-REFERENCE TO RELATED APPLICATIONS

This application claims the benefit of U.S. provisional application No. 61/691,811 filed on Aug. 22, 2012, the contents of which are herein incorporated by reference.

### TECHNICAL FIELD

The invention generally relates to social networking systems and more particularly to systems and methods for suggesting connections to colleagues in social networks.

### BACKGROUND

Social networking platforms allow people to connect with other people who have common interests. The vast growth in mobile technology has increased the popularity of social networks thereby allowing people to connect with their friends anytime and from anywhere. A social network's operators encourage people to add more people to their contacts list (e.g., colleagues and friends), as it contributes to the popularity and growth of the social network. As part of the efforts invested in trying to connect between people, social networks assist in matching people based on their mutual contacts (i.e., friends or colleagues).

However, such parameters are not particularly efficient for matching people who may not have anything more in common than one or more mutual contacts. Furthermore, as the social networks' significant interest is that users accumulate as many connections as possible, no efficient tool is provided by them to the users for the removal of inactive or otherwise stale connections from users' contact lists. It would be therefore advantageous to provide a solution that would allow users of social networks to optimize their contact lists.

### SUMMARY

Certain embodiments disclosed herein include a method for updating connections in social networks is disclosed. The method comprises analyzing information collected respective of a user, wherein the collected information relates to communication of the user with other connections through at least one application installed on a device of the user; determining connections that are of interest to the user based on the analysis information, wherein each of the determined connections is assigned with at least a communicative value; creating a user profile to include the determined connections and their respective communicative value; and updating, based on the created user profile, a connection list of the user in at least one social network to which the user is subscribed.

Certain embodiments of disclosed herein also include an agent for updating connections in social networks. The agent comprises a network interface; a data collector (DC) for monitoring at least one application executed on a client node, wherein the collected data is utilized for generating a profile of a user of the client node; a connection updater (CU) for updating, based on the user profile, a connection list of the user on at least one social network to which the user is subscribed; and a readable medium for storing at least the collected data.

### BRIEF DESCRIPTION OF THE DRAWINGS

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is a schematic block diagram of a system utilized to describe the various disclosed embodiments;

FIG. 2 is a schematic block diagram of an agent installed on a client node for suggesting updates to a user's connection lists according to an embodiment;

FIG. 3 is a flowchart of the optimization of a user connection list according to an embodiment; and

FIG. 4 is a flowchart of the process of suggesting to add or to remove one or more colleagues from a contact list according to an embodiment.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain embodiments include a system and method for optimizing contact lists on social networks. The method suggests connections that can be added to or removed from a user's connection list based on an analysis of the user's interactions. According to one embodiment, an agent is installed locally on a client node (a user device) and may be implemented as executable code and/or a firmware stored in a readable medium in the client node, hardware, or any combination thereof. The agent is configured to collect information from one or more applications installed thereon that supports interaction with colleagues. Such applications include e-mail, instant messaging, voice over Internet protocol (VoIP) communication, and the like. Collected information is analyzed and a user profile is generated respective thereof. Based on the user profile the connection list of the user on social networks is updated.

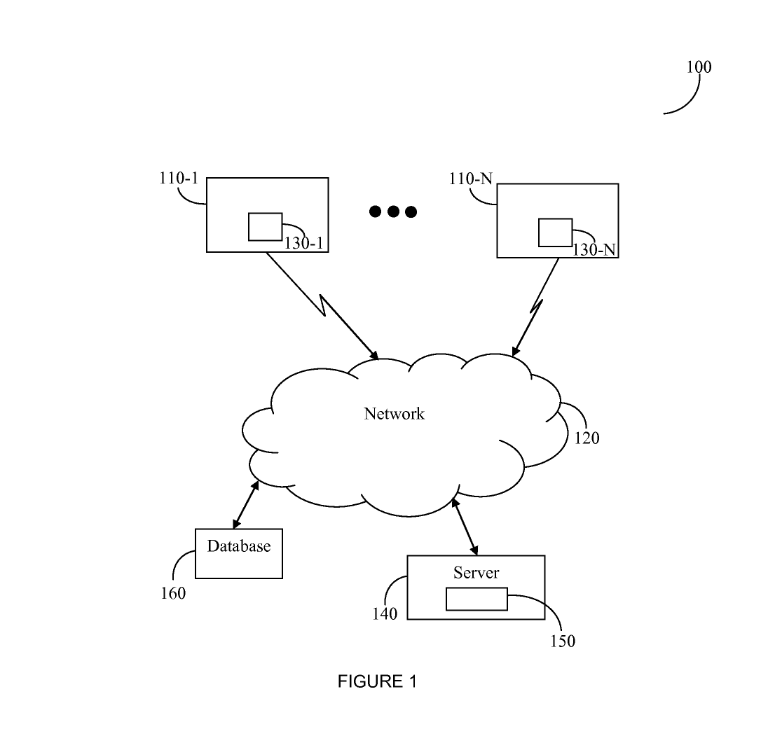

FIG. 1 depicts an exemplary and non-limiting block diagram of a system 100 utilized to describe various disclosed embodiments. A plurality of client nodes 110-1 through 110-N, are communicatively connected to the network 120. The client node 110-1 through 110-N may be a computing device including, for example, a personal computer, a tablet computer, a laptop computer, a smartphone, and the like. The network 120 may be wireless, cellular or wired, a local area network (LAN), a wide area network (WAN), a metro area network (MAN), the Internet, the worldwide web (WWW), similar networks, and any combination thereof.

Agents 130-1 through 130-N are installed on client nodes 110-1 through 110-N respectively, each being communicatively connected to a server 140 over the network 120. Each agent 130 monitors and collects information from applications installed on the respective client node 110. In one embodiment, the agent 130 monitors applications utilized for exchanging information with users of other user nodes, for example, e-mail applications, text messaging applications, instant messaging applications, VoIP applications, calendars, contacts, video conferencing applications, social network applications, document collaboration applications, enterprise network applications (e.g., SharePoint), and so on.

The agent 130 monitors such applications and extracts unstructured data identifying other users with which the user of the agent 130 exchanges information. Such data includes at least the name of the user and may also include a company, a job title, contact information, and so on.

In an exemplary embodiment, the agent 130 monitors the e-mails the user sends and receives. For outgoing e-mails the agent 130 identifies the subject headers as well as the recipients. For incoming e-mails the agent 130 also identifies the sender's subject header. The collected unstructured data is flattened, i.e., converted to a unified data format that can be analyzed, by the server 140, for the purpose of creating a user profile and optimizing the connection lists on the user's social networks' accounts. In one embodiment, the data is collected by the agent 130 over a predefined amount of time or until a predefined number of records is gathered, prior to sending the information to the server 140.

In one embodiment, the process of flattening the collected data includes creating a table to hold a plurality of records. The table designates at least the name, company, job, title, email address, a source application for the name in the entry, and the like, each of which has a specified format. For example, the name entry may have the format of {<Given Name>; <Middle Name>; <Last Name>}, thus the data flatting process ensures that all the names will be recorded in the same format. It should be noted that in certain embodiments, the raw data is sent to the server 140 which performs the data flattening processes. The information collected by agent 130 and sent to the server 140 includes an user identifier to uniquely identify the user of the client node 110.

The server 140 contains a code 150 that can be executed by the server 140. The server 140 analyzes the collected information and builds a user profile respective of the information. The user profile includes a list of people with whom the user communicates. For each listed person a communicative indication is assigned, which determines how likely the user is to communicate with the person. For example, a user profile is generated for a user named “John”, and the persons listed in his profile are “Smith” and “Mark”, assigned with a communicative value of ‘10’ and ‘5’ respectively. Therefore, John is likely to communicate more with Smith rather than Mark.

The communicative value is generated by analyzing the information collected by the agent 130. In one embodiment, the server 140 measures the frequency with which each name appears in the collected information in its unified structured format. Names with high frequency will be assigned with a higher communicative value than names with low frequency. The communicative value can be increased if a specific name appears across different applications, which is indication that the user does not communicate with the person through a limited number of sources (e.g., email).

In one embodiment, the user profile further includes an affiliation indication, i.e., whether a listed person is a social friend or a colleague of the user. The affiliation indication is determined through an analysis of the collected information. For example, if the communication with the person is through his work email address, then this indication would be a colleague.

In yet another embodiment, the commutative value assigned for each person in the user profile can be modified based on common interests and demographic similarities of the user with the respective person. The common interests and demographic similarities are determined by monitoring social network applications of the persons listed in the profile, and comparing information published therein with information shared by the user. Such published information includes age, sex, education, hobbies, current and past residential information, and so on. For example, the common interests can be determined based on the common hobbies published in the user's and other users' Facebook® accounts.

In another embodiment the analysis is made by the agent 130 locally on the client node 110-1. An advantage of such a local analysis is that the resultant profile is maintained as a private entity of the user node. In yet another embodiment, the server 140 identifies the type of device of the client node 110-1. This allows building of a user profile respective of the type of device, i.e., a different profile may be generated for a mobile device and a stationary PC as the interactions of the same user may be very different in both cases.

Based on the generated user profile the server 140 or the user nodes 110 suggests, or otherwise automatically update the user's connection lists in one more social networks the user is subscribed to. The user profile may be stored in a database 160 communicatively coupled to the server 140 and/or to the client nodes 110.

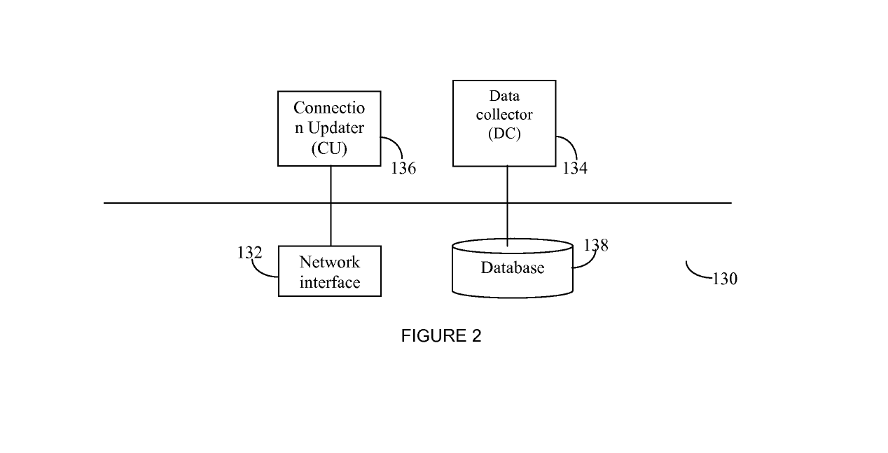

FIG. 2 depicts an exemplary and non-limiting block diagram of an agent 130 according to one embodiment. The agent 130 is installed on a client node and utilized for collecting data utilized for generation of the user profile and for generation of suggestions to add and/or to remove connections (colleagues) from a connection list. The agent 130 includes a user interface 132, a data collector 134, a connection updater 136, and a tangible readable medium 138.

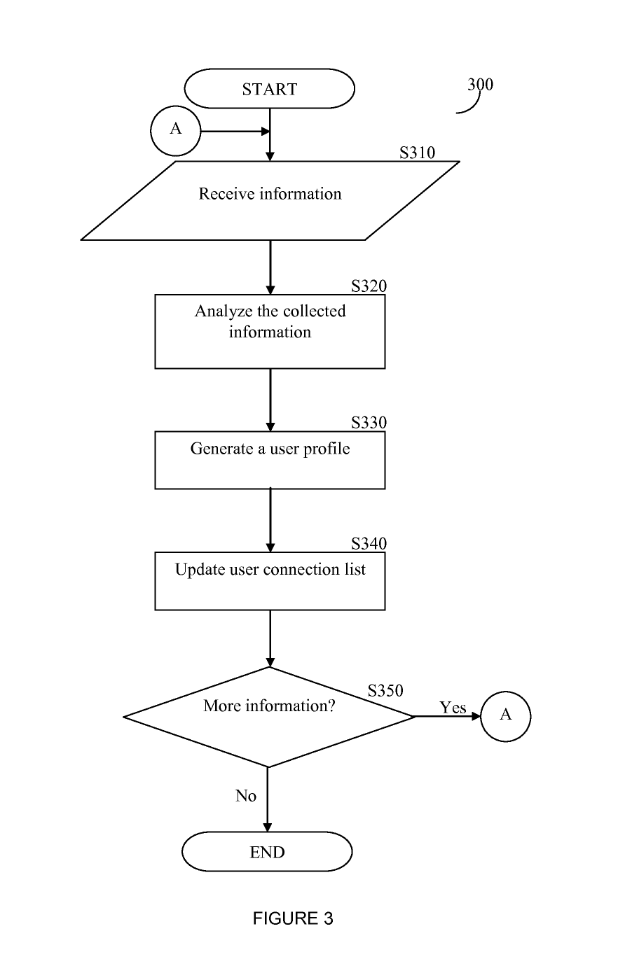

The network interface 132 is used to enable communication with the network 120. A data collector (DC) 134 collects data from applications installed on the client node 110. The data collector 134 also converts the data to a unified structure that can be analyzed by the server 140. The processes performed by the data collector 134 are described above. In one embodiment the data collector 134 is configured to generate the user profile. The connection updater (CU) 136 is configured to generate suggestions to add and/or remove connections from the user's connection lists on at least one social network. The processes performed by the connection updater 136 are described in detail with reference to FIGS. 2-3 below. The tangible readable medium 138 is used for storing the collected data and/or the generated connection suggestions.

FIG. 3 depicts an exemplary and non-limiting flowchart 300 illustrating a method for creating a user profile according to one embodiment. The user profile lists persons with which the user exchanges information; each such person is associated with a communicative value and an affiliation indication.

In S310, information collected by monitoring a plurality of applications installed on the user's device sources is received. The received information includes a user identifier as generated by the agent 130. As noted above, the monitored applications are utilized for exchanging information with other people. Various examples for such applications are provided above. In one embodiment, the information is received in a structured format generated through a data flattening process discussed above. The information structured format may be a table having a plurality of records in which all the data saved therein comply with the same format.

In S320 the collected information is analyzed, for example, by the server 140 as further described hereinabove to create or update the user profile. According to one embodiment, the analysis includes identifying in the received information names of persons with which the user (for which the profile is created) interacts or exchanges information. Then for each such person a commutative value is computed and an affiliation indication is determined as discussed above. The commutative value indicates how frequently the user interacts with a person listed in the profile. The affiliation indication designates whether the affiliation to the user is a colleague (professional relationship) or a social friend.

It should be noted that a profile can be generated to include organizations, businesses, and the like, that the user may be interested to follow. The analysis step assigns the commutative value affiliation indication for such entities as well. For example, the analysis may determine that the user exchanges information frequently with a group of person who work for a “company X”. Accordingly, the name of “company X” will be listed in the profile.

In S330 respective of the analysis, a user profile is created. The created user profile is distinguishable by the user identifier. It should be understood if a user profile already exists for the particular user, then the user profile is updated to include the new information. According to another embodiment, the user profile is stored in a database, for example, database 160.

In S340 the user connection list of the user in one more social networks to which the user is subscribed is updated respective of the user profile. In one embodiment, the generated profile is retrieved from the database 160 by an agent 130 (if such profile was generated by the server 140), which analyzes the profile and suggests new connections to the user. The retrieval of the user profile is performed using the unique user identifier. Alternatively or collectively, the agent 130 can automatically update the connection lists. It should be noted that if the process for creating the user profile is performed locally by the agent 130, then the connection update process performed by the agent 130 generates suggestions for new connections and/or updates the user's connection lists on the user's social networks. The process for updating the user connection list is described in detail below.

In S350 it is checked whether additional information is to be collected and if so, execution continues with S310; otherwise, execution terminates.

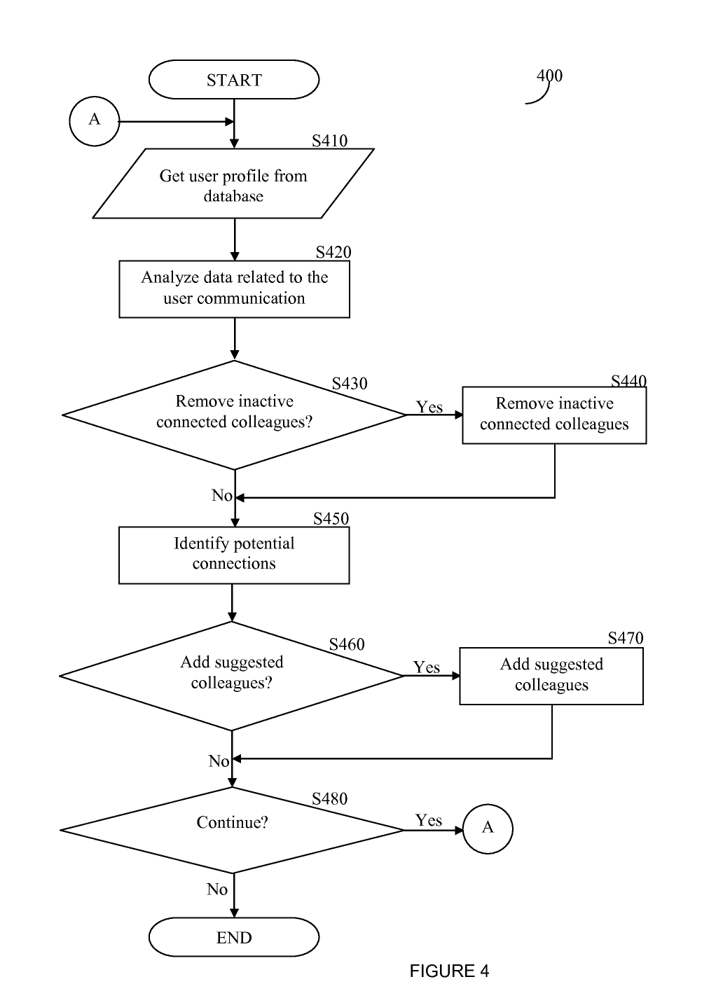

FIG. 4 depicts an exemplary and non-limiting flowchart 400 describing the process of updating a user's connections list according to an embodiment. In S410, the user profile is retrieved from the database. In S420, an analysis of the data related to the user's communication is performed by the server 140 and one or more inactive connections are identified within the user contacts. According to one embodiment, the connection lists on the social networks to which the user is subscribed are scanned by the agent 130. For each connection list of a social network, persons and organizations (collectively referred to as connections) identified by the agent are matched against the user's profile. Then, it is checked if there are connections identified in the connection list, but that do not appear in the user profile, or that appear with a commutative value below a predefined threshold. Such connections are determined to be inactive connections. In S430 it is checked whether to remove each of the inactive connections from the connection list, and if so, execution continues with S440 where the inactive colleagues are removed from the connection list; otherwise, execution continues with S450.

In one embodiment, in S440, the user of the respective user node 110 receives an indication and option to remove connections (colleagues). In another embodiment such removal is performed automatically without intervention from the user of the user node 110.

In S450, potential connections are identified as new connections that may be added to the user's connection list on a social network. In one embodiment, S450 includes matching current connections on the connection list (as identified by the agent 130) to connections listed in the user profile. New connections are determined to be connections which are not in the current connection list of the user, but are listed in the user's profile with a commutative value above a predefined threshold.

In S460 it is checked whether the user wishes to add the one or more suggested colleagues to the user's contacts and if so, execution continues with S470; otherwise, execution continues with S480. It should be noted that, in one embodiment, the user receives an indication and option to add the new connections. In another embodiment, such an addition is performed automatically without intervention from the user of the user node 110. In S470 any of the suggested colleagues approved for addition are added to the user's connection list on the respective social network. According to one embodiment, the agent 130 logs connections that the user refuses to add, and updates the user's profile to remove such connections or to reduce their commutative value. In S480 it is checked whether to continue with the execution and if so, execution continues with S410; otherwise, execution terminates.

It should be appreciated that the operation of building a user profile according to an embodiment as described in FIG. 3 and the operation of suggesting to add or to remove one or more colleagues according to an embodiment as described in FIG. 4 may be integrated without separating from the scope of the embodiments disclosed herein.

The various embodiments disclosed herein may be implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal. The display segments and mini-display segments may be shown on a display area that can be a browser or another other appropriate graphical user interface of an internet mobile application, either generic or tailored for the purposes described in detail hereinabove.

All examples and conditional language recited herein are intended for pedagogical purposes to aid the reader in understanding the principles and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for updating connections in social networks comprising:
analyzing information collected respective of a user, wherein the collected information relates to communication of the user with other connections through at least one application installed on a device of the user;
determining connections that are of interest to the user based on the analysis information, wherein each of the determined connections is assigned with at least a communicative value;
creating a user profile to include the determined connections and their respective communicative value; and
updating, based on the created user profile, a connection list of the user in at least one social network to which the user is subscribed.

2. The method of claim 1, wherein the method is performed by one of: the client node, a server communicatively connected to the client node.

3. The method of claim 1, wherein analyzing the collected information further comprises:
identifying names of connections in the collected information;
computing a frequency with which each name appeared in the collected information; and
computing the communicative value for the connection based in part on computed frequency, wherein the connection is any one of: a person and organization.

4. The method of claim 3, wherein the communicative value is computed based on at least one of demographic information and comment interest of the connection with respect to the user.

5. The method of claim 3, further comprising:
determining an affiliation indication for each connection, wherein the affiliation indication designates an affiliation of the user to the connection; and
saving the affiliation indication in the user profile.

6. The method of claim 1, wherein analyzing the collected information further comprising:
identifying the type of the client node; and
updating the user profile respective of the client node.

7. The method of claim 1, wherein the at least one application includes at least: an email application, a unified communication interaction, a social network application, a document collaboration application, an enterprise network interaction, and a data source.

8. The method of claim 4, wherein the unified communication interaction is at least one of: a chat, a phone call, a video conference, and e-mail exchanges.

9. The method of claim 1, further comprising:
storing the user profile in a database.

10. The method of claim 1, wherein updating the at least one connection list includes any least one of: adding new connections and removing inactive connections.

11. The method of claim 10, wherein removing the inactive connections further comprising:
scanning the application for the at least one connection list to identify all connections listed therein;
matching the identified connections to connections designated in the user profile;
marking, as an inactive connection, each connection in the identified connections that does not appear in the user profile or marking if its respective connection in the user profile is assigned with a communicative value of less than a predefined threshold; and
removing inactive connections from the connection list.

12. The method of claim 10, wherein adding the new connections further comprising:
scanning the application for the at least one connection list to identify all connections listed therein;
matching the identified connections to connections designated in the user profile;
marking, as a new connection, each connection in the identified connections that appears in the user profile and not in the at least one connection list; and
adding inactive connections from the connection list.

13. The method of claim 12, wherein each of the new marked connections is assigned with a communicative value that is above a predefined threshold and the assigned affiliation indication corresponds to a type of the social network of the at least one connection list.

14. A non-transitory computer readable medium having stored thereon instructions for causing one or more processing units to execute the computerized method according to claim 1.

15. A server configured to generate a user profile utilized for updating connections in social networks, comprising:
a processor communicatively connected to the network;
a memory coupled to the processor and containing a plurality of instructions that when executed by the processor, causes the server to:
analyze information collected respective of a user, wherein the collected information relates to communication of the user with other connections through at least one application installed on a device of the user;
determine connections that are of interest to the user based on the analysis information, wherein each of the determined connections is assigned with at least a communicative value; and
create a user profile to include the determined connections and their respective communicative value;
save the user profile in a database.

16. The server of claim 15, wherein the at least one application is any one of: an email application, a unified communication interaction, a social network interaction, a document collaboration application, an enterprise network interaction, and a data source.

17. The server of claim 16, wherein the unified communication interaction is one of: one or more chats, one or more phone calls, one or more video conferences or any combination thereof.

18. The server of claim 15, wherein the server is further configured to:
identify names of connections in the collected information;
compute a frequency that each name appeared in the collected information; and
compute the communicative value for the connection based in part on the computed frequency, wherein the connection is any one of: a person and organization.

19. The server of claim 15, wherein the server is further configured to:
determine an affiliation indication for each connection, wherein the affiliation indication designates an affiliation of the user to the connection; and
save the affiliation indication in the user profile.

20. An agent for updating connections in social networks comprising:
a network interface;
a data collector (DC) for monitoring at least one application executed on a client node, wherein the collected data is utilized for generating a profile of a user of the client node;
a connection updater (CU) for updating, based on the user profile, a connection list of the user on at least one social network to which the user is subscribed; and
a readable medium for storing at least the collected data.

21. The agent of claim 20, wherein the at least one application is any one of: an email application, a unified communication interaction, a social network interaction, a document collaboration application, an enterprise network interaction, and a data source.

22. The agent of claim 21, wherein the unified communication interaction is at least one of: a chat, a phone call, a video conference, and e-mail exchanges.

23. The agent of claim 22, wherein updating the at least one connection list includes at least one of: adding new connections and removing inactive connections.

24. The agent of claim 23, wherein the connection updater is configured to remove the inactive connections by:
scanning the application for the at least one connection list to identify all connections listed therein;
matching the identified connections to connections designated in the user profile;
marking, as an inactive connection, each connection in the identified connections that does not appear in the user profile or marking if its respective connection in the user profile is assigned with a communicative value of less than a predefined threshold; and
removing inactive connections from the connection list.

25. The agent of claim 22, wherein the connection updater is configured to add the new connections by:
scanning the application for the at least one connection list to identify all connections listed therein;
matching the identified connections to connections designated in the user profile;
marking, as a new connection, each connection in the identified connections that appears in the user profile and not in the at least one connection list; and
adding inactive connections from the connection list.

26. The agent of claim 25, wherein each of the new marked connections is assigned with a communicative value that is above a predefined threshold and the assigned affiliation indication corresponds to a type of the social network of the at least one connection list.

27. The agent of claim 25, wherein the data collector is further configured to generate the user profile.
